(19) United States
(12) Patent Application Publication
(10) Pub. No.: US 2023/0322353 A1
(43) Pub. Date: Oct. 12, 2023

(54) Inertia aerostat

(71) Applicant: Guangyuan XU, Zhuhai City (CN)

(72) Inventor: Guangyuan XU, Zhuhai City (CN)

(21) Appl. No.: 17/972,653

(22) Filed: Oct. 25, 2022

(30) Foreign Application Priority Data
Mar. 25, 2022 (CN) 202210302473.1

(51) Int. Cl. B64B 1/38; B64B 1/24

(52) U.S. Cl. CPC B64B 1/38; B64B 1/24

(57) ABSTRACT

An inertia aerostat having a vacuum compartment and an inertial floating device provided in the vacuum compartment, the inertial floating device comprises a drive shaft, drive devices, recycle and power generation devices and axially symmetric EMD rotation bodies, fixing devices are respectively provided at both ends of the drive shaft, the fixing devices are connected with the vacuum compartment, the drive devices are sleeved over the drive shaft, the axially symmetric EMD rotation bodies are connected with the drive devices via wheel ribs, the recycle and power generation devices are sleeved over the drive devices; by providing the vacuum compartment and the inertial floating device, inertial centrifugal forces generated by high speed rotation of the axially symmetric EMD rotation bodies in a gravitational field can be used as conversion media between kinetic energy and gravitational potential energy so free floating of the aerostat in the gravitational field can be realized.

### TECHNICAL FIELD

The present invention relates to the technical field of aerostats, and specifically, an inertia aerostat.

### BACKGROUND TECHNOLOGY

Aerostats usually refer to lighter-than-air aircrafts that gain lift through the use of a buoyant air. Aerostats include tethered balloons and airships. Tethered balloons are usually unpowered, and are connected with on-ground devices or stations via tethers; aircrafts are usually powered, and are free floating under remote or automatic control. Structurally, airships divide into non-rigid, rigid and hybrid types. Depending on flying heights, airships can also be divided into general airships, stratospheric airships, near space airships and space airships.

Conventional aerostats are floating in the air taking advantage of lighter-than-air gases, however are of a big size, which makes it difficult to change floating attitudes, low floating aerostats are liable to be influenced by atmospheric environments, and may not be able to work in very bad weather conditions.

### SUMMARY OF INVENTION

The present invention aims to provide an inertia aerostat, which can realize free floating of the aerostat in the gravitational field using inertial centrifuge forces generated by high velocity rotation of “axially symmetric even mass distribution (EMD) rotation bodies” in the gravitational field as conversion media between kinetic energy and gravitational potential energy.

Examples of the present invention are realized in the following manners:

Examples of the present invention provide an inertia aerostat, comprising a vacuum compartment, and an inertia floating device provided in the vacuum compartment, wherein the inertia floating device comprises a drive shaft, drive devices, recycle and power generation devices and axially symmetric EMD rotation bodies, both ends of the drive shaft are respectively rotationally connected with fixing devices, the fixing devices are connected with the vacuum compartment, the drive devices are sleeved over the drive shaft, the axially symmetric EMD rotation bodies are connected with the drive devices via wheel ribs, and the recycle and power generation devices are sleeved over the drive devices.

During use, start the drive devices with a remote controller, the drive devices will generate an inertial centrifugal force on the axially symmetric EMD rotation bodies via rotation of the drive shaft, the gravitational force can be offset so that the aerostat can lift aloft at a certain distance from the ground; when to reduce the inertia aerostat to a certain height, stop driving the drive devices, starting the recycle and power generation devices, the recycle and power generation devices will convert some kinetic energy of the axially symmetric EMD rotation bodies to be electrical energy and store in rechargeable power supply, at this time rotation speed of the axial symmetric EMD rotation body is reduced, the inertial centrifugal force is not sufficient to offset the gravitational force, the inertia aerostat falls back to the ground, when falling to a certain attitude or at a certain falling speed, start the drive devices again, so that the inertia aerostat remains at the certain attitude or lands on the ground slowly.

In the present invention, by configuration of the vacuum compartment and the inertial floating device, the inertial centrifugal force generated by the high speed rotation of the “axially symmetric EMD rotation bodies” (objects whose mass distributes evenly and that rotate around an axis) is used as the conversion media for kinetic energy and gravitational energy, so that free floating of the aerostat in the gravitational field can be realized.

Given precession effects of the rotation bodies caused by possible irregular disturbance during use, the vacuum compartment is placed in a support similar to a free gyroscope so to reduce impact and influence of the irregular disturbance on the inertia aerostat.

In some examples of the present invention, a three-degree-of-freedom (DOF) bearing capsule is provided outside the vacuum compartment, wherein the three-DOF bearing capsule comprises an inner bearing capsule (in a latitude direction) and an outer bearing capsule (in a longitude direction), wherein the inner bearing capsule is connected with the vacuum compartment via a first rotation support base, and the outer bearing capsule is connected with the inner bearing capsule via a second rotation support base.

In some examples of the present invention, the drive devices comprise drive motors and the rechargeable power supply, wherein stators of the drive motors are adjacent to the drive shaft, rotors of the drive motors are connected with the wheel ribs, the rechargeable power supply is connected with the drive motors and at least one charging port of the rechargeable power supply is provided in a surface of the vacuum compartment along the drive shaft. To optimize free transformation between energies and realize reversible circulation and control thereof, full electric drive and control is adopted, main power supply comprises rechargeable reversible power supply and the drive motors comprise variable frequency high speed electromechanical systems or DC brushless high speed electromechanical systems.

In some examples of the present invention, rotors of the recycle and power generation devices are adjacent to the rotors of the drive motors.

In some examples of the present invention, stators of the recycle and power generation devices are connected with the fixing device. To fix the rotors in this way requires the recycle and power generation devices to be close to the fixing devices.

In some examples of the present invention, fixing supports are provided on the stators of the recycle and power generation devices, ends of the fixing supports far away from the stators of the recycle and power generation devices are connected to the vacuum compartment. Existence of the fixing supports makes positions of the recycle and power generation devices more flexible.

In some examples of the present invention, two axially symmetric EMD rotation bodies are provided symmetrically on the drive shaft, and the drive devices and the recycle and power generation devices are correspondingly configured to be two. During design, in consideration of torque balance, the axially symmetric EMD rotation bodies are designed in pairs, the axially symmetric EMD rotation bodies are configured to be rotating coaxially and in opposite directions or coplanar and parallel (axially) so as to eliminate adverse effects to the system due to unbalance torque to a maximum degree.

In some examples of the present invention, magnetic bearings are provided at both ends of the drive devices. To reduce influence and consumption of rotation kinetic energy by the foreign world on the axially symmetric EMD rotation bodies to a maximum degree, the magnetic bearings shall be used as rotation supporting and bearing components. Magnetic bearings suspend rotors in the air via magnetic effects and no mechanical contact is present between the rotors and stators. Principles thereof are that magnetic induction lines are perpendicular to magnetic suspension lines, centers of the drive shafts are parallel to the magnetic suspension lines, therefore, weight of the rotors are fixed in the running track, and by exerting forces on the rotors contrary to the magnetic suspension lines with the centers of the drive shafts that are non-loaded, the rotors are suspended on the fixed track.

In some examples of the present invention, the axially symmetric EMD rotation bodies are connected with the drive devices via the wheel ribs.

In some examples of the present invention, the axially symmetric EMD rotation bodies are configured to be ring-shaped. To maximize rotation centrifugal forces and effects thereof, most masses of the axially symmetric EMD rotation bodies shall be near periphery of the rotation radius, therefore the axially symmetric EMD rotation bodies are configured to be ring-shaped.

Compared with the prior art, the present invention exhibits at least the following advantages or beneficial effects:

In the present invention, by configuration of the vacuum compartment and the inertia floating device, the inertial centrifugal force generated during high speed rotation of the “axially symmetric EMD rotation bodies” (objects whose mass distribution is even and rotate around a rotation axis) in a gravitational field is used as conversion media between kinetic energy and gravitational potential energy, so that the purpose of free floating of the aerostat in the gravitational field along a direction of gravitational potential energy can be realized.

### BRIEF DESCRIPTION OF DRAWINGS

To better explain the technical solutions of the present invention, hereinafter a brief description will be given to drawings to be used in the embodiments, it shall be comprehensible that, the following drawings show only some embodiments of the present invention, and therefore shall not be construed as a limitation on the scope of the present invention, for those of ordinary skill in the art, without paying creative effort, it is still possible to obtain other relevant drawings based on the drawings given here.

FIG. 1 is a schematic diagram showing internal structures of the present invention;

FIG. 2 is a schematic diagram showing entire structures of the present invention;

FIG. 3 is a schematic diagram showing physical action mechanisms of the present invention;

FIG. 4 is a schematic diagram showing a ball making uniform circular movement in a horizontal surface perpendicular to a supporting rod when no gravity acts on the ball according to the present invention;

FIG. 5 is a schematic diagram showing a ball making uniform circular movement in a speed less than the first cosmic velocity around the supporting rod when the gravity acts on the ball according to the present invention;

FIG. 6 is a schematic diagram showing a ball making uniform circular movement in a speed equal the first cosmic velocity around the supporting rod when the gravity acts on the ball according to the present invention; and

FIG. 7 is a schematic diagram showing the ball making uniform circular movement in a speed higher than the first cosmic velocity around the supporting rod when the gravity acts on the ball according to the present invention; and

FIG. 8 is a schematic diagram showing connecting relationships between rotors and stators of the drive motors and rotors and stators of the recycle and power generation devices.

In the drawings: 1, vacuum compartment; 2, drive shaft; 3, drive device; 4, recycle and power generation device; 5, axially symmetric EMD rotation body; 6, fixing device; 7, wheel rib; 8, inner bearing capsule; 9, outer bearing capsule; 10, first rotation supporting base; 11, second rotation supporting base; 12, fixing support; 13, magnetic bearing; 14, stator of the drive motor; 15, rotor of the drive motor; 16, rotor of the recycle and power generation device; and 17, stator of the recycle and power generation device.

### EMBODIMENTS

In order to make the purposes, technical solutions and advantages of the embodiments of the present invention clearer, the technical solutions in the embodiments of the present invention will be clearly and completely described below with reference to the accompanying drawings of the embodiments of the present invention. Obviously, the described embodiments are only some embodiments of the present invention, rather than all embodiments. The components in the embodiments of the present invention described and illustrated in the drawings herein may be arranged and designed in a variety of different configurations.

Thus, the following detailed description of the embodiments of the present invention provided in the accompanying drawings is not intended to limit the scope of the present invention as claimed, but shows merely some preferred embodiments of the present invention. Based on the embodiments of the present invention, all other embodiments obtained by those of ordinary skill in the art without creative efforts shall fall within the protection scope of the present invention.

It should be noted that similar numerals and letters refer to similar items in the following drawings, so once an item is defined in one drawing, it does not require further definition and explanation in subsequent drawings.

In the description of the embodiments of the present invention, it should be noted that if the terms “center”, “upper”, “lower”, “left”, “right”, “vertical”, “horizontal”, “inner” and “outside” are used, the orientation or positional relationship indicated by them is based on the orientation or positional relationship shown in the accompanying drawings, or the orientation or positional relationship that the product of the present invention is placed, which is only for the convenience of describing the present invention and simplifying the description, and does not indicate or imply that the device or element must have a particular orientation, be constructed and operated in a particular orientation, and therefore should not be construed as limiting the present invention. Furthermore, the terms “first”, “second”, “third”, etc. are only used to differentiate the description and should not be construed as indicating or implying relative importance.

Furthermore, the appearance of the terms “horizontal”, “vertical”, “overhanging” etc. does not imply that the component is required to be absolutely horizontal or overhanging, but may be slightly inclined. For example, “horizontal” only means that its direction is more horizontal than “vertical”, it does not mean that the structure must be completely horizontal, but can be slightly inclined.

In the description of the embodiments of the present invention, “a plurality of” means at least two.

In the description of the embodiments of the present invention, it should also be noted that, unless otherwise expressly specified and limited, the terms “set”, “installed” and “connected” should be understood in a broad sense. It can be a fixed connection, a detachable connection, or an integral connection; it can be a mechanical connection or an electrical connection; it can be a direct connection, or an indirect connection through an intermediate medium, and it can be internal communication between two components. For those of ordinary skill in the art, the specific meanings of the above terms in the present invention can be understood according to specific situations.

### Embodiment 1

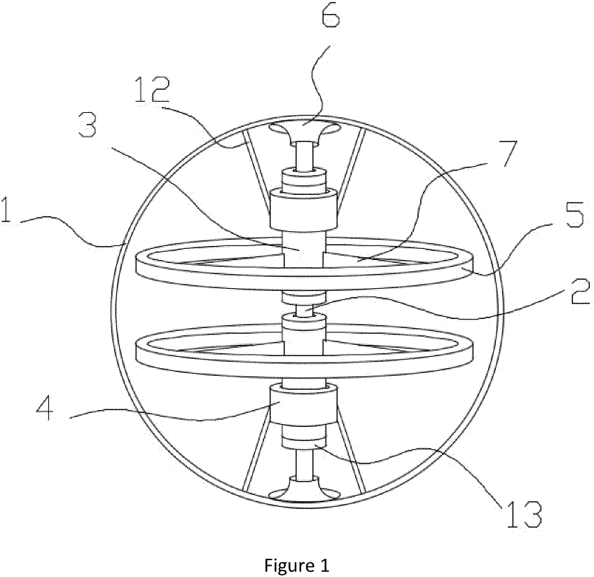

The present invention provides an inertial aerostat, as shown in FIG. 1, comprising a vacuum compartment 1, and an inertial floating device provided in the vacuum compartment, the inertial floating device comprise a drive shaft 2, drive devices 3, recycle and power generation devices 4, axially symmetric EMD rotation bodies 5, fixing devices 6 are provided at both ends of the drive shafts 2, the fixing devices 6 are connected with the vacuum compartment 1, the drive devices 3 are sleeved on the drive shaft 2, the axially symmetric EMD rotation bodies 5 are connected with the drive devices 3 via wheel ribs, and the recycle and power generation devices 4 are respectively sleeved on the drive devices 3.

During use, first of all, start the drive devices 3 with a remote controller, the drive devices 3 generate inertial centrifugal forces by rotation of the axially symmetric EMD rotation bodies 5 to offset gravitational forces so as to gain lift and stay at a certain distance from the ground; when to reduce attitude of the inertial aerostat, the drive devices 3 stop driving and in the meanwhile the recycle and power generation devices 4 start working, the recycle and power generation devices 4 convert some energies of the axially symmetric EMD rotation bodies 5 to be electric energy and store the same in the rechargeable power supply, at this time, rotation speeds of the axially symmetric EMD rotation bodies 5 are reduced, the inertial centrifugal forces are not sufficient to offset the gravitational forces, therefore, the inertial aerostat returns to the ground, and when falling to a certain height or reaching a certain falling speed, start again the drive devices 3, so that the inertial aerostat stays at the certain height or lands slowly.

In the present invention, by configuration of the vacuum compartment 1 and the inertial floating device, the inertial centrifugal forces generated in a gravitational field by high speed rotation of the axially symmetric EMD rotation bodies 5 are used as conversion media between kinetic energy and gravitational potential energy, so as to realize free floating of the aerostat in the gravitational field.

### Embodiment 2

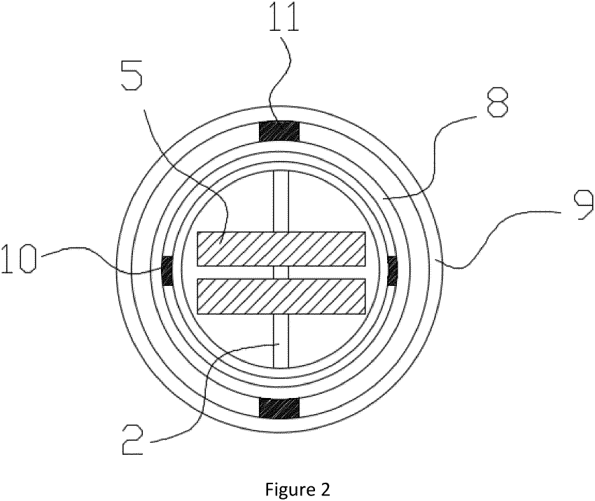

The present embodiment provides an inertial aerostat, as shown in FIG. 2, the inertial aerostat in the present embodiment is basically the same as the one provided in the embodiment 1, and main differences lie in that: a three-DOF bearing capsule is provided outside the vacuum compartment 1, the three-DOF bearing capsule comprises an inner bearing capsule 8 and an outer bearing capsule 9, the inner bearing capsule 8 is connected with the vacuum compartment 1 via a first rotation support base 10 and the outer bearing capsule 9 is connected with the inner bearing capsule 8 via a second rotation support base 11. Given precession effects that may occur in the axially symmetric EMD rotation bodies 5 due to possible irregular disturbance during use, the vacuum compartment 1 can be placed in a support similar to a free gyroscope so as to reduce impact and influences to the inertial aerostat by the irregular disturbance from foreign world.

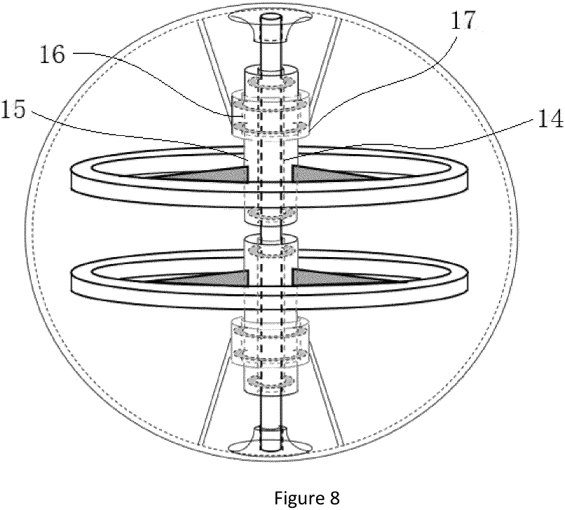

Further, as shown in FIG. 8, the drive devices 3 comprise drive motors and rechargeable power supply, stators of the drive motors 14 are adjacent to the drive shaft 2, rotors of the drive motors 15 are connected with the wheel ribs 7, and at least one charging port of the rechargeable power supply is configured to be in a surface of the vacuum compartment 1. In the present invention, to optimize free transformation between energies and reversible circulation and control of energies, drive and control is done fully with electric, the main power supply comprises rechargeable reversible power supply and the drive motors comprise variable frequency high speed electromechanical systems or DC brushless high speed electromechanical systems.

### Embodiment 3

The present embodiment provides an inertial aerostat as shown in FIG. 8, which is basically the same as the one in the embodiment 1 or 2, and main differences lie in that: rotors of the recycle and power generation devices 16 are adjacent to the rotors of the drive motors 15.

Further, stators of the recycle and power generation devices 17 are connected with the fixing devices 6. To fix the stators in this way requires the recycle and power generation devices 4 to be close to the fixing devices 6.

Further, fixing supports 12 are provided at the stators of the recycle and power generation devices 17, ends of the fixing supports 12 away from the stators of the recycle and power generation devices 17 are fixed on the vacuum compartment 1. Existence of the fixing supports 12 allows positions of the recycle and power generation devices 4 to be more flexible.

### Embodiment 4

The present embodiment provides an inertial aerostat, as shown in FIG. 1, which is basically the same as the one in the embodiment 1, 2 or 3, and main differences lie in that: two axially symmetric EMD rotation bodies 5 are symmetrically provided on the drive shaft 2, and both the drive devices 3 and the recycle and power generation devices 4 are configured to be two, corresponding to the axially symmetric EMD rotation bodies 5. Actually in consideration of torque balance the axially symmetric EMD rotation bodies 5 are configured to be in pairs, for example, configured to be coaxial and rotating in opposite directions, or coplanar and parallel (axially) so to eliminate adverse influences on the system due to torque imbalance to a maximal extent.

Further, as shown in FIG. 1, magnetic bearings 13 are provided at both ends of the drive devices 3. To reduce influences and consumption from the foreign world on rotation energy of the axially symmetric EMD rotation bodies 5, the magnetic bearings 13 are used as rotation movement support and bearing components. The magnetic bearings 13 keep the rotors suspended via magnetic effects, so that no mechanical contact is present between the rotors and the stators. Principles behind the magnetic bearings 13 are that, magnetic induction lines are perpendicular to magnetic suspension lines, a core of the shaft is parallel to the magnetic suspension lines, so weights of the rotors are fixed in a running track and by shoring with an almost load free core of the shaft in a direction contrary to the magnetic suspension lines, the entire rotors are suspended in a fixed running track.

### Embodiment 5

The present invention provides an inertial aerostat, which is substantially the same as any one of the embodiment 1, 2, 3 or 4, and main differences between them are: the axially symmetric EMD rotation bodies 5 are connected with the drive devices 3 via the wheel ribs 7. Further, as shown in FIG. 1, the axially symmetric EMD rotation bodies 5 are ring-shaped. In order to maximize rotation centrifugal forces and effects, most parts of the axially symmetric EMD rotation bodies 5 are configured to be at a periphery of the rotation radius, that is, the axially symmetric EMD rotation bodies 5 are configured to be ring-shaped.

### Embodiment 6

The present embodiment provides an inertial aerostat, and please find the following explanation:

### Principles Description

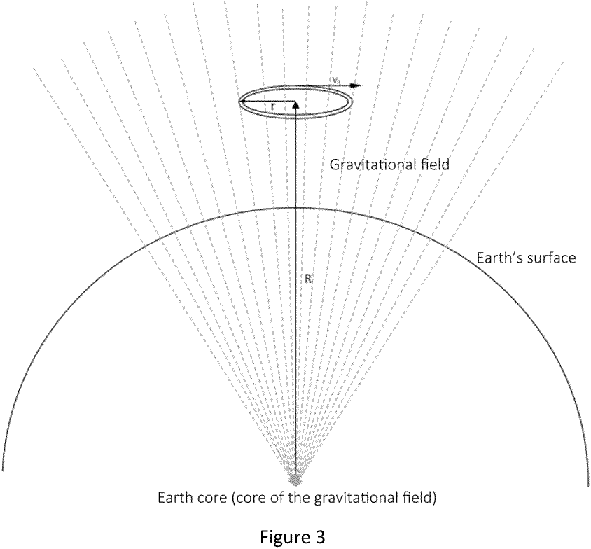

As shown in FIG. 3, similar to the decisive instrumental role that magnetic field forces play during free transformation processes between kinetic energies and electrical potential energies, inertial centrifugal forces that a moving mass body excites in a gravitational field play a decisive meditation role in free transformation between the kinetic energies and gravitational potential energies. The present inertial aerostat takes use of the inertial centrifugal forces generated by high speed rotation of the axially symmetric EMD rotation bodies as conversion media between kinetic energies and gravitational potential energies, so that the entire system (the inertial aerostat) floats freely in the gravitational field along a direction of the gravitational potential energy.

### Components of the Device:

The inertial aerostat comprises three important parts, namely, axially symmetric EMD rotation bodies that are coaxial and rotating in opposite directions and holding systems thereof, a kinetic energy supply system and an energy transformation and recycling system.

### Manufacturing Method:

Axially symmetric EMD rotation bodies that are coaxial and rotating in opposite directions and holding devices and systems thereof In order to maximize centrifugal effects from rotation motions, most of the axially symmetric EMD rotation bodies are provided at a periphery of the rotation radius, that is, the axially symmetric EMD rotation bodies are configured to be ring-shaped, and the wheel ribs are made from very light however firm materials; the main shaft for supporting, driving and transmission shall also be made from light however stable materials. In practical design, in consideration of torque balance, the axially symmetric EMD rotation bodies are configured to be in pairs, that are coaxial and rotating in opposite directions or coplanar and parallel (axially) so as to maximally eliminate adverse effects due to torque imbalance to the system. Furthermore, in order to reduce to a maximum extent influence and consumption of the foreign world to the axially symmetric EMD rotation bodies, magnetic bearings are used as rotation supporting and bearing components; in the meanwhile, rotating parts of the axially symmetric EMD rotation bodies shall be configured in a sealed cavity of a certain vacuum degree (the higher the better). Furthermore, in consideration of the precession effects of possible irregular disturbance to the axially symmetric EMD rotation bodies during use, the entire device and system can be placed into a bearing and supporting frame similar to a free gyroscope, so as to reduce impact and influence to the system by irregular disturbance of the foreign world.

### The Kinetic Energy Supply and Drive System

In the present invention, to optimize free transformation and reversible circulation and control of the energies, enabling systems at terminals are done by full electric drive and control, main power supply comprises rechargeable and reversible power supply, and the drive motors comprise variable frequency high speed electromechanical systems or DC brushless high speed electromechanical system.

### Energy Recycle and Feedback System

To realize reversible circulation and control of kinetic energies and gravitational potential energies, two sets of power generation systems are concatenated on the main drive shaft (one set next to each of the twin axially symmetric EMD rotation bodies), as required the rotational kinetic energies of the axially symmetric EMD rotation bodies can be converted to be electrical energy and store in the main power supply.

By integrating the foregoing systems, reversible circulation and control of the following energy loop can be achieved smoothly: electric potential energy ⇄ kinetic energy ⇄ gravitational potential energy.

### Properties and Operation Characteristics of the Device:

The present device is named inertial aerostat as the device uses inertial centrifugal forces as media to generate effects to offset gravitational forces, so that the entire system (the device itself and the load) can float freely in a gravitational field along a direction of gravitational potential energy.

After starting the device, with continuous increase of the rotation speeds of the axially symmetric EMD rotation bodies, when linear velocity V of the axially symmetric EMD rotation bodies with a mass of m₀ satisfies conditions as shown in the following equation ①:

$${\text{M}}_{0} * {\text{V}}^{2} / \text{R} \geq \text{G} * {\text{M}}_{\text{earth}} * \text{m} / {\text{R}}^{2} \qquad \text{①}$$

(annotation: in the foregoing equation, m₀ is an effective rotation mass of the axially symmetric EMD rotation bodies; V is a linear velocity of the axially symmetric EMD rotation bodies; G is a gravitational constant in the classic law of gravitation; R is a distance from a mass center of the aerostat to a mass center of the earth.)

When the linear velocity of the axially symmetric EMD rotation bodies of the device satisfies the foregoing condition, the inertial centrifugal forces generated by the axially symmetric even mass distribution rotation bodies relative to the earth core is sufficient to offset the gravitational force, therefore, the aerostat will lift and stay in a corresponding height, and by maintaining the rotation speed of the axially symmetric EMD rotation bodies, the entire aerostat system will suspend in the corresponding height and remain there.

To change attitude of the aerostat, for example, to go up for a difference of H meters, when not considering any energy loss, just provide some rotation kinetic energy E to the axially symmetric EMD rotation bodies via the electric drive system, as the inertial centrifugal force at the left end of the foregoing equation ① after energizing exceeds the gravitational force, therefore, the aerostat gains an upward differential drive force, and is lifted to the corresponding attitude under action of the differential drive force (the gravitational potential energy increased), and the specific lifting attitude difference can be determined by the following binary simultaneous equations:

$$\left\{\begin{matrix}{\text{-G*M}}_{\text{earth}} \text{*} \text{m} / \text{R} + {\text{m}}_{\text{0}} \text{*} {\text{V}}^{\text{2}} {}_{\text{R}} / \text{2} \text{+E} = \\ {\text{-G*M}}_{\text{earth}} \text{*} \text{m} / \left(\text{R+H}\right) {\text{+m}}_{\text{0}} \text{*} {\text{V}}^{\text{2}} {}_{\text{+H}} / \text{2} - - - - 2 \\ \\ {\text{M}}_{\text{0}} \text{*} {\text{V}}^{\text{2}} {}_{\text{+H}} / \left(\text{R+H}\right) = {\text{G*M}}_{\text{earth}} \text{*} \text{m} / {\left(\text{R+H}\right)}^{\text{2}} - - - - 3\end{matrix}\right)$$

(note: in the foregoing equations, R is a distance of the aerostat from the center of the earth before changing attitude, V_{R} is the linear velocity of axially symmetric EMD rotation bodies in the aerostat before changing attitude, V_{+H} is the linear velocity of the axially symmetric EMD rotation bodies after floating and attitude change for H meters of the aerostat, and meanings of other characters are the same as those in the equation ①.)

Similarly, to have the aerostat to change attitude downwards for a difference of H meters, without considering any energy loss, just start the power generation system concatenated in the main drive shaft of the axially symmetric EMD rotation bodies, recycle rotation energy E of corresponding amount, therefore, as the inertial centrifugal force at the left end of the equation ① is less than the gravitational force during recycle and storage of the rotation energy, the aerostat will obtain a downward differential drive force, under action of the downward differential drive force, the aerostat is reduced to the corresponding height (position of the gravitational potential energy reduced), and the specific attitude reduction difference can be determined via the following binary equations ④ and ⑤ simultaneously:

$$\left\{\begin{matrix}{\text{-G*M}}_{\text{earth}} \text{*} \text{m} / \text{R} {\text{+m}}_{\text{0}} \text{*} {\text{V}}^{\text{2}} {}_{\text{R}} / \text{2} - \text{E} = \\ {\text{-G*M}}_{\text{earth}} \text{*} \text{m} / \left(\text{R-H}\right) {\text{+m}}_{\text{0}} \text{*} {\text{V}}^{\text{2}} {}_{\text{-H}} / \text{2} - - - - 4 \\ \\ {\text{M}}_{\text{0}} \text{*} {\text{V}}^{\text{2}} {}_{\text{-H}} / \left(\text{R-H}\right) = {\text{G*M}}_{\text{earth}} \text{*} \text{m} / {\left(\text{R-H}\right)}_{\text{2}} - - - - 5\end{matrix}\right)$$

(note: in the foregoing equation, R is a distance of the aerostat to the center of the earth before changing attitude, V_{R} is a linear velocity of the axially symmetric EMD rotation bodies in the aerostat by changing attitude, V_{-H} is a linear velocity of the axially symmetric EMD rotation bodies in the aerostat after attitude reducing for H meters, and meaning of the other characters are the same as those in the equation ①.)

### Embodiment 7

The present embodiment provides an inertial aerostat, and to better understand the working principles of the inertial aerostat, first of all, conduct the following experiment based on existing physical principles and practices:
First, to reflect essence of physical actions, let’s make the following assumptions: Suppose there is a rigid ball with a mass of m, the ball is infinitely small (can be understood to be a mass center having weight);
Suppose there is a rigid pull rope with a length of r that is infinitely thin;
Suppose there is a rigid support frame that is firmly fixed and not deformable; Suppose there is no rotation friction at where the pull rope is connected with a fixing pole of the support frame;
And suppose the entire system is in an absolute vacuum.

Based on the foregoing assumptions, we can make systematic movement analysis in the following cases:

First of all, assume that the system is located in an ideal environment that is not subject to any force field, therefore, when the ball makes tangential centripetal movements, at this time, as there is no influence from any foreign force field, no matter how much the speed of the ball is (as long as the speed is not zero), the running track of the ball will be as shown in the attached FIG. 1, permanently making uniform circular movements (with a radius of r) along a horizontal plane perpendicular to the support pole.

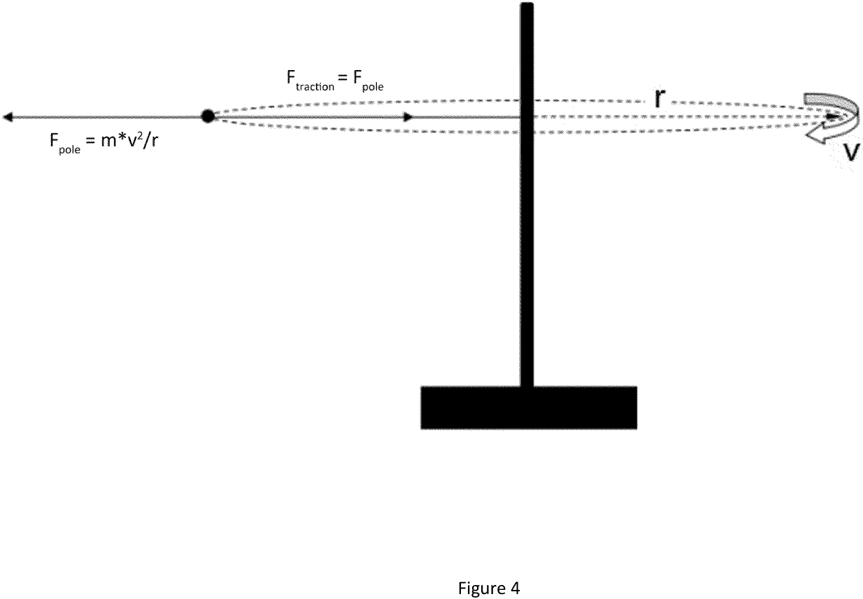

Herein, as shown in FIG. 4, the ball is subject only to the inertial centrifugal force toward the support pole Fₚₒₗₑ = m*v²/r and a traction force F from the pull rope, and under action of the pair of balance forces (the foregoing two forces are opposite and equal), the ball is stably making uniform circular movements.

In case the system is placed in a central gravitational potential field like the earth (the direction of the support pole is along the gravitational field lines), under limitation of the pull rope, the ball with a linear velocity of v when makes centripetal circular movement around the support pole, the running track of the ball will be subjected to influences of forces from four directions, that is: force of gravity F_{gravity} = G*M_{gravity}*m/R² (R is a distance from the mass center of the ball to the center of the earth); the traction force from the pull rope F_{traction}; the inertial centrifugal force generated by the ball relative to a center point of a traction horizontal circular plane Fₚₒₗₑ = m*v²/r; and another force (liable to be neglected when the speed is low) is the inertial centrifugal force generated by the ball relative to a center of the gravitational field (the center of the earth)

$${\text{F}}_{\text{center}} = \text{m*} {\text{v}}^{2} / \text{R} .$$

Hereinafter we use the first cosmic velocity as a boundary, analysis will be respectively given to three speed conditions along with the drawings (tangential velocity of the ball is far lower than the first cosmic velocity; the tangential velocity of the ball equals the first cosmic velocity and the tangential velocity of the ball is higher than the first cosmic velocity).

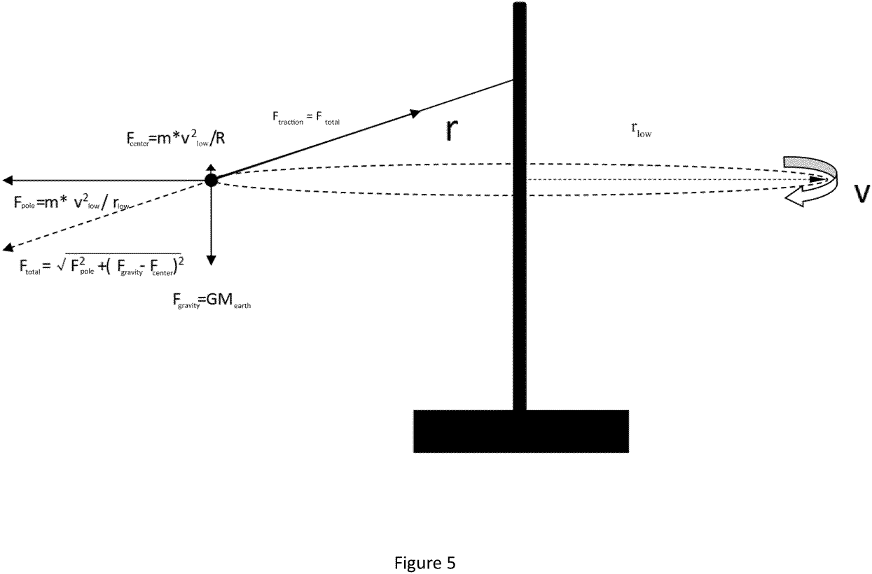

In the first case: as shown in FIG. 5, at a quite low speed (the running speed of the ball is far lower than the first cosmic velocity), the inertial centrifugal force generated by the ball in the gravitational field relative to the center of the earth F_{center} is very small, and hence is almost negligible. At this time, the running track of the ball is mainly dictated by the traction force from the pull rope F_{traction}, the inertial centrifugal force generated around the traction and rotation center Fₚₒₗₑ, and the force of gravity exerted on the ball F_{gravity}. At this time, the running track of the ball is making horizontal circular movement around a center under the traction and fixing center perpendicular to a plane of the support rod along the support rod (suppose the radius is r_{low}).

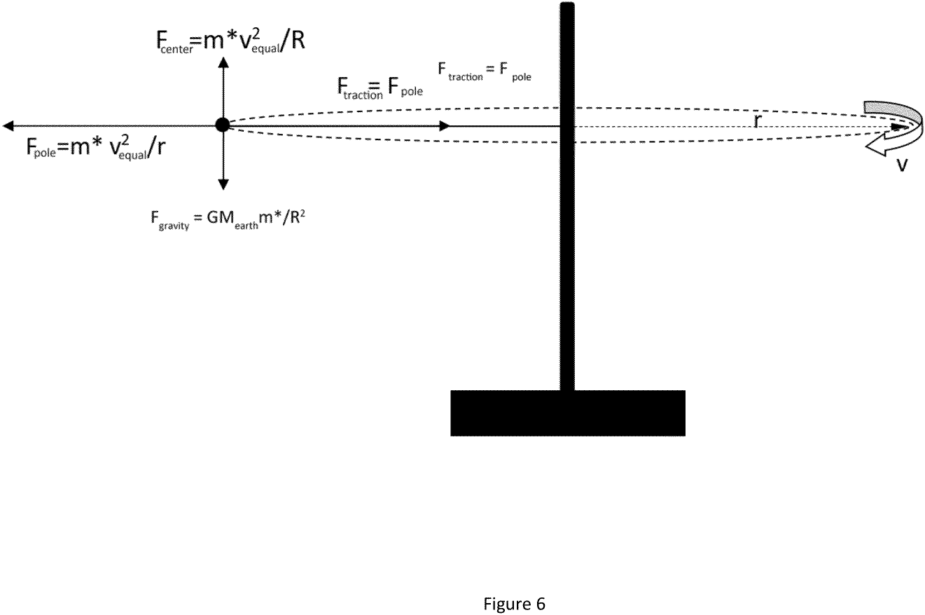

In the second case: as shown in FIG. 6, when the speed of the ball reaches the first cosmic speed, the inertial centrifugal force F_{center} relative to the center of the earth and the force of gravity F_{gravity} are opposite and equal. Therefore, influences from the inertial centrifugal force F_{center} on the running track of the ball becomes apparent. In this way, the running track of the ball is horizontal and circular along a plane perpendicular to the support rod around the traction and fixing center as a center.

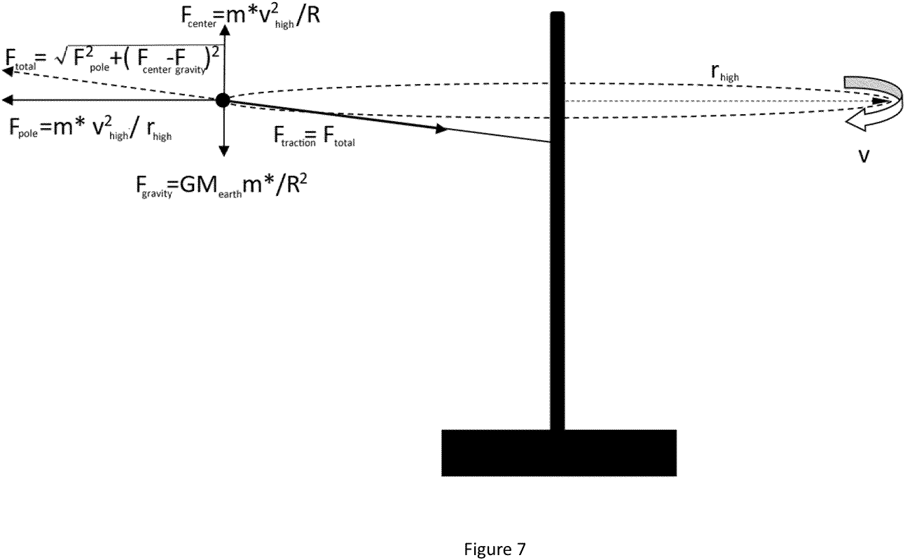

In the third case: as shown in FIG. 7, when the moving speed of the ball exceeds the first cosmic speed (at this time, the inertial centrifugal force plays its inherent role), at this time, as the inertial centrifugal force relative to the center of the earth is larger than the force of gravity, the ball is supposed to be subjected to an upward differential drive force, under action of the differential drive force, the ball moves upwards spirally until a new mechanical equilibrium is reached (specifically equations corresponding to force balance in energy conservation and steady movement conditions) and is suspended at the corresponding height and making uniform circular movement. At this time, the movement track of the ball shall be horizontal circular movements around a center in a direction along the support pole above the traction and fixing center perpendicular to the plane of the support pole.

By analysis to running states of the ball in the foregoing three ideal conditions, it can be known that, with gradual increase of the speed, the inertial centrifugal force F_{center} relative to the center of the earth is changing, from negligible to apparent then to predominant, experiencing a physical process from quantitative change to qualitative change. And in the foregoing three running states, if we suppose the surface of the earth is a uniform and flat standard sphere, and suppose that the surface of the earth is located in an absolute vacuum environment, when the foregoing two conditions are met; at this time, suppose we free the ball from the traction rope, then in the second case as mentioned above (the speed of the ball reaches the first cosmic velocity), the ball will instantly depart and run around a standard circular track around the center of the earth above the surface of the earth and will no longer fall on the ground. Similarly, in case in the third case as mentioned above, the ball will run along a standard oval track around the earth after departing from the earth. The foregoing two cases are basic operation ways of modern satellites, and have been fully verified and used in practices. However, our use of the inertial centrifugal force is still limited to running along a big cycle track around the earth; and for other potential application of them (the physical mechanism and principles and application and design methods as explained in the present invention) until now no one has done deep researches and exploration thereon.

By the foregoing mechanical action mechanism deduction, theoretically and practically, the physical application principles and the device design method proposed in the present invention are well established on profound theoretical and pragmatic basis.

### Brief Introduction of Design Principles of the Inertial Aerostat

Based on the foregoing physical principles, the following practical application and design of the inertial aerostat can be done:

Prior to explaining design principles of the inertial aerostat device, as having similar energy transformation mechanism and principles, first of all let us retrospect basic physical principles and application and design thoughts observed during application of kinetic energy and electric potential energy transformation. We know the basic physical rules that modern power generators (electric motors) follow, are the Lorentz force that moving charged particles (electron) are subjected to in a uniform and steady magnetic field; the Lorentz force is a centripetal force not doing work on acting particles but can serve as an energy transmission medium so as to create necessary conditions for free transformation between kinetic energy and electrical potential energy. However, during actual design (here power generators are used as an example), to optimize expected effects of energy transformation, first of all, restrain and limit moving directions of the charges during energy transformation, that is, set that the charges can move only along force line directions of the Lorentz force that the charges are subjected to, so that a cylindrical shaped straight conduction lines can be optimized and selected; lastly, choose conductors that are rich in charges and have high conductivity (such as copper and aluminum to reduce internal consumption). By the foregoing restraint and limitation, a useful and efficient power generator system can be made.

Similar to properties of the Lorentz force that the charges experience in a magnetic field, the inertial centrifugal force that an object exhibits in an equipotential surface of the gravitational field is perpendicular to the moving direction of the object (corresponding to a direction of the centripetal force acting thereon), the inertial centrifugal force doesn’t do work on the acting object, but can be used as a conversion medium (similar to the Lorentz force) to achieve free transformation between the kinetic energy and gravitational potential energy in the gravitational field.

Similar to the design and manufacturing principles of the power generators, when designing and manufacturing the inertial aerostat first of all, restrain and set moving directions of corresponding object, and select shapes, density and materials of core parts (the axially symmetric EMD rotation bodies). To ensure consistency between the moving direction and the direction of the inertial centrifugal force when the objects move and are stressed, the moving objects are limited to be making circular movement around a fixed mass center, so that the shape of the axially symmetric EMD rotation bodies being ring-shaped is determined; secondly, for materials high density, high rigidity and high tenacity is preferred and also the material shall be highly uniform and easy to make; furthermore, magnetic bearing systems are chosen and the entire system is placed in a vacuum closed cavity, and all the configurations are made to maximally reduce internal loss and consumption. Also the entire core device body is placed in a free gyroscope, and reasons for that are to isolate foreign influences; and to further enhance safety of the device, so as to promise that, when extreme fault conditions occur, two layers of ball capsules at the outside can function efficiently for isolation and protection purpose.

In summary, the embodiments of the present invention provide an inertial aerostat, having at least the following advantages and beneficial effects:

In the present invention, by providing the vacuum compartment and the inertial aerostat, the inertial centrifugal force generated by the axially symmetric EMD rotation bodies that are rotating at high speed in a gravitational field can serve as conversion media between kinetic energy and gravitational potential energy, so as to achieve free floating of the aerostat in the gravitational field.

The foregoing are only some preferred embodiments of the present invention, and are not intended to limit the present invention, for those skilled in the art, the present invention can have many different variations and changes. All modifications, equivalent replacement and improvements made within the spirit and principles of the present invention shall be covered in the protection scope of the present invention.

1. An inertia aerostat, comprising
a vacuum compartment, and
an inertia floating device provided in the vacuum compartment, wherein the inertia floating device comprises
a drive shaft,
drive devices,
recycle and power generation devices and
axially symmetric EMD rotation bodies, wherein
both ends of the drive shaft are respectively rotationally connected with fixing devices, the fixing devices are connected with the vacuum compartment, the drive devices are sleeved over the drive shaft, the axially symmetric EMD rotation bodies are connected with the drive devices via wheel ribs, and the recycle and power generation devices are sleeved over the drive devices.

2. The inertia aerostat as defined in claim 1, wherein a three degree-of-freedom bearing capsule is provided outside the vacuum compartment, the three DOF bearing capsule comprises an inner bearing capsule and an outer bearing capsule, the inner bearing capsule is connected to the vacuum compartment via a first rotation supporting base and the outer bearing capsule is connected to the inner bearing capsule via a second rotation supporting base.

3. The inertia aerostat as defined in claim 1, wherein the drive devices comprise drive motors and the rechargeable power supply, wherein stators of the drive motors are adjacent to the drive shaft, rotors of the drive motors are connected with the wheel ribs, the rechargeable power supply is connected with the drive motors and at least one charging port of the rechargeable power supply is provided in a surface of the vacuum compartment along the drive shaft.

4. The inertia aerostat as defined in claim 3, wherein rotors of the recycle and power generation devices are provided at extension sides of casings of the rotors of the drive motors.

5. The inertia aerostat as defined in claim 4, wherein stators of the recycle and power generation devices are connected with the fixing devices.

6. The inertia aerostat as defined in claim 4, wherein fixing supports are provided on the stators of the recycle and power generation devices, ends of the fixing supports far away from the stators of the recycle and power generation devices are connected to the vacuum compartment.

7. The inertia aerostat as defined in claim 1, wherein two axially symmetric EMD rotation bodies are provided symmetrically on the drive shaft, and the drive devices and the recycle and power generation devices are correspondingly configured to be two.

8. The inertia aerostat as defined in claim 1, wherein magnetic bearings are provided at both ends of the drive devices.

9. The inertia aerostat as defined in claim 3, wherein the axially symmetric EMD rotation bodies are connected with the drive devices via the wheel ribs.

10. The inertia aerostat as defined in claim 7, wherein the axially symmetric EMD rotation bodies are configured to be ring-shaped.
